(19) United States
(12) Patent Application Publication
(10) Pub. No.: US 2004/0132621 A1
(43) Pub. Date: Jul. 8, 2004

(54) Microemulsion concentrates

(75) Inventors: Gerhard Frisch, Wehrheim (DE); Detlev Haase, Frankfurt (DE); Thomas Maier, Hofheim (DE); Gerhard Schnabel, Elsenfeld (DE)

Correspondence Address: CONNOLLY BOVE LODGE & HUTZ, LLP, P O BOX 2207, WILMINGTON, DE, 19899, US

(73) Assignee: Bayer CorpScience GmbH Patents and Licensing, Frankfurt am Main (DE)

(21) Appl. No.: 10/739,708

(22) Filed: Dec. 17, 2003

(30) Foreign Application Priority Data
Dec. 17, 2002 (DE) DE 102 58 867.8

(51) Int. Cl. A01N 25/04; A01N 25/16

(52) U.S. Cl. 504/363; 504/364

(57) ABSTRACT

The present invention relates to a microemulsion concentrate comprising

a) one or more agrochemical active ingredients,

b) one or more nonalcoholic organic solvents,

c) one or more anionic surfactants, and

d) one or more nonionic surfactants.

The microemulsion concentrate is suitable in the field of crop protection.

The present invention relates to the field of crop protectant formulations. In particular, the invention relates to liquid formulations in the form of microemulsion concentrates which comprise agrochemical active ingredients.

Active ingredients for crop protection are generally not employed in their pure form. Depending on the field and type of application, and on physical, chemical and biological parameters, the active ingredient is employed as a mixture with conventional adjuvants and additives as a solid or liquid active ingredient formulation.

Liquid formulations are described, for example, in EP 0 261 492, EP 0 394 847, WO 95/17822, WO 98/31223, WO 89/03176, EP 0 357 149, WO 02/45507, GB 2 267 825 A, WO 94/23578, EP 0 330 904, EP 0 533 057, EP 0 533 057, DE 36 24 910, WO 01/74785, EP 0 400 585 and EP 0 118 579.

The object of the present invention was to provide an improved crop protectant formulation with superior chemical and physical stability and agrochemical activity.

Surprisingly, it has now been found that this object is achieved by the specific microemulsion concentrate (MC) of the present invention.

Thus, the present invention relates to a microemulsion concentrate comprising

a) one or more agrochemical active ingredients,

b) one or more nonalcoholic organic solvents,

c) one or more anionic surfactants, and

d) one or more nonionic surfactants.

In addition, the microemulsion concentrate according to the invention may, if appropriate, additionally comprise conventional adjuvants and additives as further components.

The term microemulsion concentrate (MC) is understood as meaning a composition which forms microemulsions upon dilution with water, for example oil-in-water microemulsions or water-in-oil microemulsions. A microemulsion is understood as being an emulsion which is thermodynamically stable and has a droplet size of the emulsified phase which is generally in the range of 10-400 nm, preferably 50-250 nm.

In general, the microemulsion concentrates according to the invention comprise the following amounts of components a), b), c) and d), where “% by weight” here and in all of the description, unless otherwise defined, refers to the relative weight of the component in question based on the total weight of the formulation:

Component a): 0.001-50% by weight, preferably 0.1-30% by weight, especially preferably 2-25% by weight.

Component b): 10-90% by weight, preferably 20-85% by weight, especially preferably 25-80% by weight.

Component c): 0.1-25% by weight, preferably 1-20% by weight, especially preferably 2-15% by weight.

Component d): 0.1-60% by weight, preferably 1.5-45% by weight, especially preferably 2-40% by weight.

Suitable agrochemical active ingredients a) are, for example, herbicides, insecticides, fungicides, safeners and growth regulators. Preferred active ingredients are herbicides, for example foliar-acting herbicides such as ALS inhibitors (for example sulfonamides such as flucarbazone, propoxycarbazone or amicarbazone, or sulfonylureas such as mesosulfuron, iodosulfuron, amidosulfuron, foramsulfuron), diflufenican, bromoxynil- or ioxynil-comprising products, herbicides from the aryloxyphenoxypropionate class such as fenoxaprop-p-ethyl, sugarbeet herbicides such as desmedipham, phenmedipham, ethofumesate or metamitron, glyphosate or glufosinate or else active ingredients from the class of the HPPD inhibitors (for example isoxaflutole, sulcotrione, mesotrione).

Examples of herbicides present in the microemulsion concentrates according to the invention are ALS inhibitors (acetolactate synthetase inhibitors) or herbicides other than ALS inhibitors, such as herbicides from the group of the carbamates, thiocarbamates, haloacetanilides, substituted phenoxy-, naphthoxy- and phenoxy-phenoxycarboxylic acid derivatives and heteroaryloxyphenoxyalkanecarboxylic acid derivatives such as quinolyloxy-, quinoxalyloxy-, pyridyloxy-, benzoxazolyloxy- and benzothiazolyloxyphenoxyalkanecarboxylic esters, cyclohexanedione derivatives, phosphorus-containing herbicides, for example those of the glufosinate type or of the glyphosate type, and S-(N-aryl-N-alkylcarbamoylmethyl)-dithiophosphoric esters.

The ALS inhibitors are, in particular, imidazolinones, pyrimidinyloxypyridinecarboxylic acid derivatives, pyrimidyloxybenzoic acid derivatives, triazolopyrimidinesulfonamide derivatives, and sulfonamides, preferably from the sulfonylurea group.

The active ingredients from the group of the ALS inhibitors, such as sulfonylureas, which are present in the microemulsion concentrates according to the invention as component are to be understood as meaning, for the purposes of the present invention, not only the neutral compounds, but always also their salts with inorganic and/or organic counterions. For example, sulfonylureas may, for example, form salts in which the hydrogen of the —SO₂—NH— group is replaced by an agriculturally suitable cation. These salts are, for example, metal salts, in particular alkali metal salts or alkaline earth metal salts, in particular sodium and potassium salts, or else ammonium salts or salts with organic amines. Likewise, salts may be formed by an addition reaction between an acid and basic groups, such as, for example, amino and alkylamino. Acids which are suitable for this purpose are strong inorganic and organic acids, for example HCl, HBr, H₂SO₄ or HNO₃.

Preferred ALS inhibitors are from the series of the sulfonylureas, for example pyrimidine- or triazinylaminocarbonyl[benzene-, pyridine-, pyrazole-, thiophene- and (alkylsulfonyl)alkylamino]sulfamides. Preferred substituents on the pyrimidine ring or triazine ring are alkoxy, alkyl, haloalkoxy, haloalkyl, halogen or dimethylamino, it being possible for all substituents to be combined independently of one another. Preferred substituents in the benzene, pyridine, pyrazole, thiophene or (alkylsulfonyl)alkylamino moiety are alkyl, alkoxy, halogen such as F, Cl, Br or I, amino, alkylamino, dialkylamino, acylamino such as formylamino, nitro, alkoxycarbonyl, aminocarbonyl, alkylaminocarbonyl, dialkylaminocarbonyl, alkoxyaminocarbonyl, halogenoalkoxy, halogenoalkyl, alkylcarbonyl, alkoxyalkyl, alkylsulfonylaminoalkyl, (alkanesulfonyl)alkylamino. Examples of such suitable sulfonylureas are

A1) phenyl- and benzylsulfonylureas and related compounds, for example

1-(2-chlorophenylsulfonyl)-3-(4-methoxy-6-methyl-1,3,5-triazin-2-yl)urea (chlorosulfuron),

1-(2-ethoxycarbonylphenylsulfonyl)-3-(4-chloro-6-methoxypyrimidin-2-yl)urea (chlorimuron-ethyl),

1-(2-methoxyphenylsulfonyl)-3-(4-methoxy-6-methyl-1,3,5-triazin-2-yl)urea (metsulfuron-methyl),

1-(2-chloroethoxyphenylsulfonyl)-3-(4-methoxy-6-methyl-1,3,5-triazin-2-yl)urea (triasulfuron),

1-(2-methoxycarbonylphenylsulfonyl)-3-(4,6-dimethylpyrimidin-2-yl)urea (sulfumeturon-methyl),

1-(2-methoxycarbonylphenylsulfonyl)-3-(4-methoxy-6-methyl-1,3,5-triazin-2-yl)-3-methylurea (tribenuron-methyl),

1-(2-methoxycarbonylbenzylsulfonyl)-3-(4,6-dimethoxypyrimidin-2-yl)urea (bensulfuron-methyl),

1-(2-methoxycarbonylphenylsulfonyl)-3-(4,6-bis-(difluoromethoxy)pyrimidin-2-yl)-urea, (primisulfuron-methyl),

3-(4-ethyl-6-methoxy-1,3,5-triazin-2-yl)-1-(2,3-dihydro-1,1-dioxo-2-methylbenzo-[b]thiophene-7-sulfonyl)urea (EP-A 0 796 83),

3-(4-ethoxy-6-ethyl-1,3,5-triazin-2-yl)-1-(2,3-dihydro-1,1-dioxo-2-methylbenzo[b]-thiophene-7-sulfonyl)urea (EP-A 0 079 683),

3-(4-methoxy-6-methyl-1,3,5-triazin-2-yl)-1-(2-methoxycarbonyl-5-iodo-phenyl-sulfonyl)urea (iodosulfuron-methyl and its salts such as the sodium salt, WO 92/13845),

DPX-66037, triflusulfuron-methyl (s. Brighton Crop Prot. Conf.—Weeds—1995, p. 853),

CGA-277476, (s. Brighton Crop Prot. Conf.—Weeds—1995, p. 79), methyl-2-[3-(4,6-dimethoxypyrimidin-2-yl)ureidosulfonyl]-4-methanesulfonamidomethylbenzoate (mesosulfuron-methyl and its salts such as the sodium salt, WO 95/10507),

N,N-dimethyl-2-[3-(4,6-dimethoxypyrimidin-2-yl)ureidosulfonyl]-4-formylaminobenzamide (foramsulfuron and its salts such as the sodium salt, WO 95/01344);

A2) thienylsulfonylureas, for example

1-(2-methoxycarbonylthiophen-3-yl)-3-(4-methoxy-6-methyl-1,3,5-triazin-2-yl)urea (thifensulfuron-methyl);

A3) pyrazolylsulfonylureas, for example

1-(4-ethoxycarbonyl-1-methylpyrazol-5-yl-sulfonyl)-3-(4,6-dimethoxypyrimidin-2-yl)urea (pyrazosulfuron-methyl);

methyl-3-chloro-5-(4,6-dimethoxypyrimidin-2-ylcarbamoylsulfamoyl)-1-methylpyrazole-4-carboxylate (EP-A 0 282 613);

5-(4,6-dimethylpyrimidin-2-yl-carbamoylsulfamoyl)-1-(2-pyridyl)pyrazole-4-carboxylate (NC-330, s. Brighton Crop Prot. Conference ‘Weeds’ 1991, Vol.1, p. 45 ff.),

DPX-A8947, azimsulfuron, (s. Brighton Crop Prot. Conf. ‘Weeds’ 1995, p. 65);

A4) sulfonediamide derivatives, for example

3-(4,6-dimethoxypyrimidin-2-yl)-1-(N-methyl-N-methylsulfonylaminosulfonyl)urea (amidosulfuron) and its structural analogs (EP-A 0 131 258 and Z. Pfl. Krankh. Pfl. Schutz, Sonderheft XII, 489-497 (1990));

A5) pyridylsulfonylureas, for example

1-(3-N,N-dimethylaminocarbonylpyridin-2-ylsulfonyl)-3-(4,6-dimethoxypyrimidin-2-yl)urea (nicosulfuron),

1-(3-ethylsulfonylpyridin-2-ylsulfonyl)-3-(-(4,6-dimethoxypyrimidin-2-yl)urea (rimsulfuron),

2-[3-(4,6-dimethoxypyrimidin-2-yl)ureidosulfonyl]-6-trifluoromethyl-3-pyridine-carboxylate, sodium salt (DPX-KE 459, flupyrsulfuron, s. Brighton Crop Prot. Conf. Weeds, 1995, p. 49), trifloxysulfuron and its sodium salt;

A6) alkoxyphenoxysulfonylureas, as are described for example in EP-A 0 342 569, preferably 3-(4,6-dimethoxypyrimidin-2-yl)-1-(2-ethoxyphenoxy)-sulfonylurea (ethoxysulfuron) or its salts;

A7) imidazolylsulfonylureas, for example

MON 37500, sulfosulfuron (s. Brighton Crop Prot. Conf. ‘Weeds’, 1995, p. 57), and other related sulfonylurea derivatives and their mixtures.

Typical representatives of these active ingredients are, inter alia, the compounds listed hereinbelow and their salts: amidosulfuron, azimsulfuron, bensulfuron-methyl, chlorimuron-ethyl, chlorsulfuron, cinosulfuron, cyclosulfamuron, ethametsulfuron-methyl, ethoxysulfuron, flazasulfuron, flupyrsulfuron-methyl-sodium, halosulfuron-methyl, imazosulfuron, metsulfuron-methyl, nicosulfuron, oxasulfuron, primisulfuron-methyl, prosulfuron, pyrazosulfuron-ethyl, rimsulfuron, sulfometuron-methyl, sulfosulfuron, thifensulfuron-methyl, triasulfuron, tribenuron-methyl, trifloxysulfuron and its sodium salt, triflusulfuron-methyl, iodosulfuron-methyl and its sodium salt (WO 92/13845), mesosulfuron-methyl and its sodium salt (Agrow No. 347, Mar. 3, 2000, page 22 (PJB Publications Ltd. 2000)) and foramsulfuron and its sodium salt (Agrow No. 338, Oct. 15, 1999, page 26 (PJB Publications Ltd. 1999)).

The active ingredients listed above are known from, for example, “The Pesticide Manual”, 12th edition (2000), The British Crop Protection Council or the references mentioned after the individual active ingredients.

Examples of further suitable ALS inhibitors are

B) imidazolinones, for example

methyl 2-(4-isopropyl-4-methyl-5-oxo-2-imidazolin-2-yl)-5-methylbenzoate and 2-(4-isopropyl-4-methyl-5-oxo-2-imidazolin-2-yl)-4-methylbenzoic acid (imazamethabenz), 5-ethyl-2-(4-isopropyl-4-methyl-5-oxo-2-imidazolin-2-yl)pyridine-3-carboxylic acid (imazethapyr),

2-(4-isopropyl-4-methyl-5-oxo-2-imidazolin-2-yl)quinoline-3-carboxylic acid (imazaquin),

2-(4-isopropyl-4-methyl-5-oxo-2-imidazolin-2-yl)pyridine-3-carboxylic acid (imazapyr),

5-methyl-2-(4-isopropyl-4-methyl-5-oxo-2-imidazolin-2-yl)pyridine-3-carboxylic acid (imazethamethapyr);

C) triazolopyrimidinesulfonamide derivatives, for example

N-(2,6-difluorophenyl)-7-methyl-1,2,4-triazolo[1,5-c]pyrimidine-2-sulfonamide (flumetsulam),

N-(2,6-dichloro-3-methylphenyl)-5,7-dimethoxy-1,2,4-triazolo[1,5-c]pyrimidine-2-sulfonamide,

N-(2,6-difluorophenyl)-7-fluoro-5-methoxy-1,2,4-triazolo[1,5-c]pyrimidine-2-sulfonamide,

N-(2,6-dichloro-3-methylphenyl)-7-chloro-5-methoxy-1,2,4-triazolo[1,5-c]pyrimidine-2-sulfonamide,

N-(2-chloro-6-methoxycarbonyl)-5,7-dimethyl-1,2,4-triazolo[1,5-c]pyrimidine-2-sulfonamide (EP-A 0 343 752, U.S. Pat. No. 4,988,812);

D) pyrimidinyloxypyridinecarboxylic acid and pyrimidinyloxybenzoic acid derivatives, for example

benzyl 3-(4,6-dimethoxypyrimidin-2-yl)oxypyridine-2-carboxylate (EP-A 0 249 707),

methyl 3-(4,6-dimethoxypyrimidin-2-yl)oxypyridine-2-carboxylate (EP-A 0 249 707),

2,6-bis[(4,6-dimethoxypyrimidin-2-yl)oxy]benzoic acid (EP-A 0 321 846),

1-(ethoxycarbonyloxyethyl) 2,6-bis[(4,6-dimethoxypyrimidin-2-yl)oxy]benzoate (EP-A0 472 113).

The herbicidal active ingredients which differ from ALS inhibitors and which are present in the microemulsion concentrates according to the invention are, for example, herbicides from the group of the carbamates, thiocarbamates, halogenoacetanilides, substituted phenoxy-, naphthoxy- and phenoxyphenoxy-carboxylic acid derivatives and heteroaryloxyphenoxyalkanecarboxylic acid derivatives such as quinolyloxy-, quinoxalyloxy-, pyridyloxy-, benzoxazolyloxy- and benzothiazolyloxyphenoxyalkanecarboxylic esters, cyclohexanedione derivatives, phosphorus-containing herbicides, for example of the glufosinate type or of the glyphosate type, and S-(N-aryl-N-alkylcarbamoylmethyl)dithiophosphoric esters. Preferred in this context are phenoxyphenoxy- and heteroaryloxyphenoxycarboxylic acid esters and salts, and herbicides such as bentazone, cyanazine, atrazine, dicamba or hydroxybenzonitriles such as bromoxynil and ioxynil and their salts and esters, and other foliar-acting herbicides.

Examples of suitable herbicidal active ingredients which differ from ALS inhibitors and which may be present in the microemulsion concentrates according to the invention as component are:

E) herbicides of the type of the phenoxyphenoxy- and heteroaryloxyphenoxycarboxylic acid derivatives, such as

E1) phenoxyphenoxy- and benzyloxyphenoxycarboxylic acid derivatives, for example methyl 2-(4-(2,4-dichlorophenoxy)phenoxy)propionate (diclofop-methyl),

methyl 2-(4-(4-bromo-2-chlorophenoxy)phenoxy)propionate (DE-A 26 01 548),

methyl 2-(4-(4-bromo-2-fluorophenoxy)phenoxy)propionate (U.S. Pat. No. 4,808,750),

methyl 2-(4-(2-chloro4-trifluoromethylphenoxy)phenoxy)propionate (DE-A 24 33 067),

methyl 2-(4-(2-fluoro-4-trifluoromethylphenoxy)phenoxy)propionate (U.S. Pat. No. 4,808,750),

methyl 2-(4-(2,4-dichlorobenzyl)phenoxy)propionate (DE-A 24 17 487),

ethyl 4-(4-(4-trifluoromethylphenoxy)phenoxy)pent-2-enoate,

methyl 2-(4-(4-trifluoromethylphenoxy)phenoxy)propionate (DE-A 24 33 067);

E2) “mononuclear” heteroaryloxyphenoxyalkanecarboxylic acid derivatives, for example

ethyl 2-(4-(3,5-dichloropyridyl-2-oxy)phenoxy)propionate (EP-A 0 002 925),

propargyl 2-(4-(3,5-dichloropyridyl-2-oxy)phenoxy)propionate (EP-A 0 003 114),

methyl 2-(4-(3-chloro-5-trifluoromethyl-2-pyridyloxy)phenoxy)propionate (EP-A 0 003 890),

ethyl 2-(4-(3-chloro-5-trifluoromethyl-2-pyridyloxy)phenoxy)propionate (EP-A 0 003 890),

propargyl 2-(4-(5-chloro-3-fluoro-2-pyridyloxy)phenoxy)propionate (EP-A 0 191 736),

butyl 2-(4-(5-trifluoromethyl-2-pyridyloxy)phenoxy)propionate (fluazifop-butyl);

E3) “binuclear” heteroaryloxyphenoxyalkanecarboxylic acid derivatives, for example

methyl and ethyl 2-(4-(6-chloro-2-quinoxalyloxy)phenoxy)propionate (quizalofop-methyl and quizalofop-ethyl),

methyl 2-(4-(6-fluoro-2-quinoxalyloxy)phenoxy)propionate (s. J. Pest. Sci. Vol. 10, 61 (1985)),

2-isopropylideneaminooxyethyl 2-(4-(6-chloro-2-quinoxalyloxy)phenoxy)propionate (propaquizafop),

ethyl 2-(4-(6-chlorobenzoxazol-2-yloxy)phenoxy)propionate (fenoxaprop-ethyl), its D(+) isomer (fenoxaprop-P-ethyl) and ethyl 2-(4-(6-chlorobenzothiazol-2-yl-oxy)phenoxy)propionate (DE-A 26 40 730),

tetrahydro-2-furylmethyl 2-(4-(6-chloroquinoxalyloxy)phenoxy)propionate (EP-A 0 323 727);

F) chloroacetanilides, for example

N-methoxymethyl-2,6-diethylchloroacetanilide (alachlor),

N-(3-methoxyprop-2-yl)-2-methyl-6-ethylchloroacetanilide (metolachlor),

2,6-dimethyl N-(3-methyl-1,2,4-oxadiazol-5-ylmethyl)chloroacetanilide,

N-(2,6-dimethylphenyl)-N-(1-pyrazolylmethyl)-chloroacetamide (metazachlor);

G) thiocarbamates, for example

S-ethyl-N,N-dipropylthiocarbamate (EPTC),

S-ethyl-N,N-diisobutylthiocarbamate (butylate);

H) cyclohexanedione oximes, for example

methyl 3-(1-allyloxyiminobutyl)-4-hydroxy-6,6-dimethyl-2-oxocyclohex-3-enecarboxylate, (alloxydim),

2-(1-ethoxyiminobutyl)-5-(2-ethylthiopropyl)-3-hydroxycyclohex-2-en-1-one (sethoxydim),

2-(1-ethoxyiminobutyl)-5-(2-phenylthiopropyl)-3-hydroxycyclohex-2-en-1-one (cloproxydim),

2-(1-(3-chloroallyloxy)iminobutyl)-5-(2-ethylthiopropyl)-3-hydroxycyclohex-2-en-1-one,

2-(1-(3-chloroallyloxy)iminopropyl)-5-(2-ethylthiopropyl)-3-hydroxycyclohex-2-en-1-one (clethodim),

2-(1-ethoxyiminobutyl)-3-hydroxy-5-(thian-3-yl)cyclohex-2-enone (cycloxydim),

2-(1-ethoxyiminopropyl)-5-(2,4,6-trimethylphenyl)-3-hydroxycyclohex-2-en-1-one (tralkoxydim);

I) benzoylcyclohexanediones, for example

2-(2-chloro-4-methylsulfonylbenzoyl)cyclohexane-1,3-dione (SC-0051, EP-A 0 137 963), 2-(2-nitrobenzoyl)-4,4-dimethylcyclohexane-1,3-dione (EP-A 0 274 634),

2-(2-nitro-4-methylsulfonylbenzoyl)-4,4-dimethylcyclohexane-1,3-dione (WO 91/13548, mesotrione);

J) S-(N-aryl-N-alkyl-carbamoylmethyl)dithiophosphonic ester, such as O,O-dimethyl S-[N-(4-chlorphenyl)-N-isopropylcarbamoylmethyl] dithiophosphate (anilophos).

K) alkylazines, for example as described in WO-A 97/08156, WO-A-97/31904, DE-A-19826670, WO-A-98/15536, WO-A-8/15537, WO-A-98/15538, WO-A-98/15539 or else DE-A-19828519, WO-A-98/34925, WO-A-98/42684, WO-A-99/18100, WO-A-99/19309, WO-A-99/37627 and WO-A-99/65882, preferably those of the formula (I)

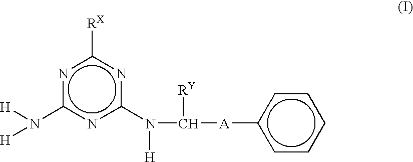

in which

R^{X} is (C₁-C₄)-alkyl or (C₁-C₄)-haloalkyl;

R^{Y} is (C₁-C₄)-alkyl, (C₃-C₆)-cycloalkyl or (C₃-C₆)-cycloalkyl-(C₁-C₄)-alkyl and

A is —CH₂—, —CH₂—CH₂—, —CH₂—CH₂—CH₂—, —O—, —CH₂—CH₂—O—, —CH₂—CH₂—CH₂—O—, especially preferably those of the formula I1-I7

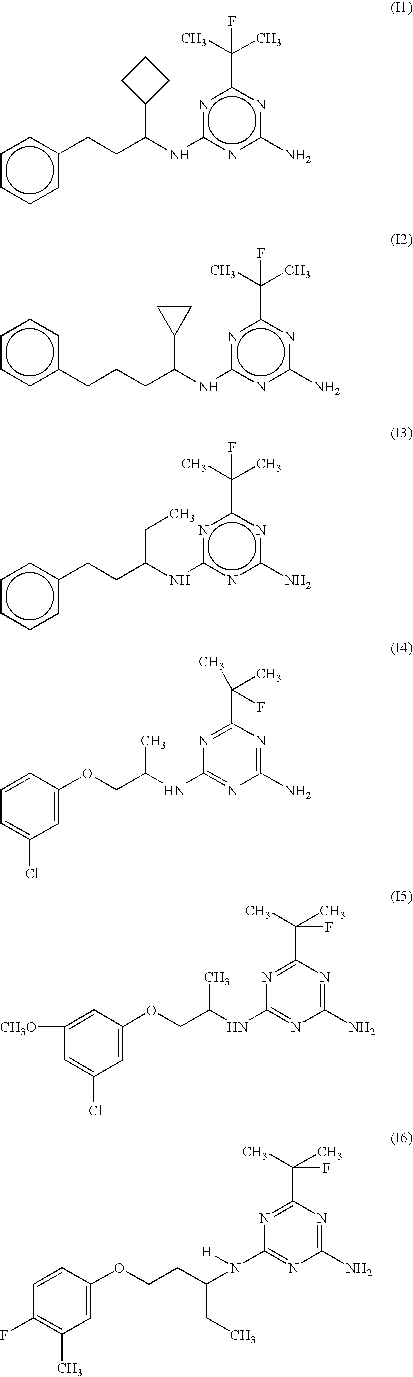

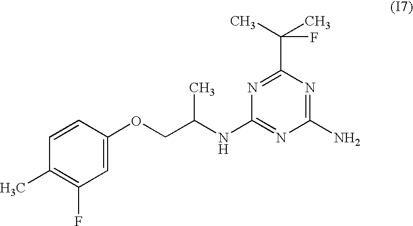

L) phosphorus-containing herbicides, for example of the glusosinate type, such as glufosinate in the stricter sense, i.e. D,L-2-amino-4-[hydroxy(methyl)phosphinyl]butanoic acid, glufosinate monoammonium salt, L-glufosinate, L- or (2S)-2-amino-4-[hydroxy(methyl)phosphinyl]butanoic acid, L-glufosinate monoammonium salt or bialaphos (or bilanafos), i.e. L-2-amino-4-[hydroxy(methyl)phosphinyl]butanoyl-L-alanyl-L-alanine, in particular its sodium salt, or of the glyphosate type, such as glyphosate, i.e. N-(phosphonomethyl)glycine, glyphosate monoisopropylammonium salt, glyphosate sodium salt, or sulfosate, i.e. N-(phosphonomethyl)glycine trimesium salt=N-(phosphonomethyl)glycine trimethylsulfoxonium salt.

The herbicides of groups B to L are known for example from the publications, each of which is mentioned above, and from “The Pesticide Manual”, 12th edition, 2000, The British Crop Protection Council, “Agricultural Chemicals Book II—Herbicides—”, by W. T. Thompson, Thompson Publications, Fresno Calif., USA 1990 and “Farm Chemicals Handbook '90”, Meister Publishing Company, Willoughby Ohio, USA,1990.

Preferred among the agrochemical active ingredients a) which are present in the microemulsion concentrates of the present invention are:

acetochlor, aclonifen, alachlor, amidochlor, amidosulfuron, bensulfuron-methyl, bromoxynil octanoate, butachlor, chlorsulfuron, cinosulfuron, clodinafop-propargyl, cypermethrin, 2,4-D ester, 2,4-DB ester, 2,4-DP ester, CMPP ester, MCPA ester, deltamethrin, desmedipham, diclofop-methyl, diflufenican, ethofumesate, fenxoapropethyl, fipronil, fluoroglycofen, foramsulfuron, imazapyr, imazosulfuron, iodosulfuron-methyl, imidocloprid, ioxynil octanoate, isoxaflutole, lactofen, mesosulfuron-methyl, metolachlor, metsulfuron-methyl, metamitron, nicosulfuron, oxyfluorfen, pendimethalin, phenmedipham, primisulfuron-methyl, propaquizafop, pyrazosulfuron-methyl, rimsulfuron, triflusulfuron-methyl, trifluralin, iodosulfuron, prochloraz, amitraz, oxazinone, oxadiargyl, metamitron, mefenpyrdiethyl, phenmedipham, desmedipham, isoxadifen-ethyl, and their salts, for example the sodium salts.

Suitable nonalcoholic organic solvents b) are solvents which contain no alcohol group, for example hydrocarbons, carboxylic acid derivatives, phosphoric acid esters, ethers, ketones or sulfoxides such as dimethylsulfoxide.

Examples of hydrocarbons (see, for example, Römpp Lexikon Chemie [Römpp Dictionary of Chemistry], 10th edition, volume 3, page 2202 (1997), Georg Thieme Verlag Stuttgart/New York) are preferably those which are liquid under standard conditions. The hydrocarbons can be acyclic (aliphatic) hydrocarbons or cyclic hydrocarbons, for example aromatic or alicyclic (cycloaliphatic) hydrocarbons.

Examples of hydrocarbons b) are:

1) aromatic hydrocarbons, for example

aromatic hydrocarbons which are mono- or polysubstituted by alkyl (for example mono-, di- or trisubstituted by (C₁-C₁₀)alkyl), for example benzenes such as toluene, xylenes, mesitylene, ethylbenzene, or

hydrocarbons with fused aromatic ring systems such as naphthalenes, for example 1-methylnaphthalene, 2-methylnaphthalene or dimethylnaphthalene, or other fused aromatic hydrocarbons such as indane or tetralin,

2) cycloaliphatic hydrocarbons, for example

saturated or unsaturated, cycloaliphatic hydrocarbons which are optionally mono- or polysubstituted by alkyl (for example mono-, di- or trisubstituted by (C₁-C₁₀)alkyl) such as cycloalkanes, cycloalkenes or cycloalkynes, for example cyclohexane or methylcyclopentane,

3) aliphatic hydrocarbons, for example

linear or branched, saturated or unsaturated aliphatic hydrocarbons, preferably C₅-C₁₆-aliphatic hydrocarbons, for example alkanes, alkenes or alkynes, such as pentane, hexane, octane, 2-methylbutane or 2,2,4-trimethylpentane.

Mixtures of one or more aromatic hydrocarbons and/or one or more cycloaliphatic hydrocarbons and/or one or more aliphatic hydrocarbons may also be present as component b). Examples are mixtures of aliphatic hydrocarbons, for example commercially available solvents from the EXXSOL®D series, ISOPAR® series or BAYOL® series, for example Bayol®82 (EXXONMOBIL CHEMICALS) or from the ISANE®IP series or HYDROSEAL®G series (TOTALFINAELF), or mixtures of aromatic and aliphatic hydrocarbons, for example commercially available solvents from the SOLVESSO® series, for example Solvesso®100, Solvesso®150 or Solvesso®200 (EXXONMOBIL CHEMICALS), the SOLVAREX®/SOLVARO® series (TOTALFINAELF) or the Caromax® series, for example Caromax®28 (Petrochem Carless).

Aliphatic hydrocarbons, in particular saturated aliphatic hydrocarbons, such as C₅-C₁₆-alkanes, for example from the Bayol® series, are preferred.

Examples of carboxylic acid derivatives are, for example, esters or amides of carboxylic acids.

Suitable carboxylic acid derivatives are, for example, the esters and amides of monocarboxylic acids, dicarboxylic acids or polycarboxylic acids such as trifunctional or tetrafunctional carboxylic acids or carboxylic acids with a higher functionality, preferably those with 2-26 carbon atoms.

Preferred esters are the esters with C₁-C₂₀-alcohols (for example methanol, ethanol, propanol or butanol); especially preferred in the case of fatty acid esters are also the glycerol and glycol esters. Suitable carboxylic esters are also internal esters such as lactones.

Examples of monocarboxylic esters are the esters of aliphatic and aromatic monocarboxylic acids, for example aliphatic C₁-C₉-monocarboxylic esters such as formic esters, acetic esters and propionic esters, or aliphatic fatty acid esters such as C₁₀-C₂₂-fatty acid esters, for example those of natural origin, as are present in natural oils or vegetable oils, or synthetic origin, or aromatic C₇-C₂₂-monocarboxylic esters such as benzoic esters or phenylacetic esters.

Examples of fatty acid esters are for example those of natural origin, for example natural oils such as animal oils or vegetable oils, or of synthetic origin, for example Edenor®MESU or AGNIQUE®ME series (COGNIS), of the SALIM®ME series (SALIM), the STEPAN®C series (STEPAN) or the WITCONOL®23 series (WITCO). Preferred as fatty acid esters are esters of C₁₀-C₂₂-, preferably C₁₂-C₂₀-fatty acids. The C₁₀-C₂₂-fatty acid esters are, for example, esters of unsaturated or saturated C₁₀-C₂₂-fatty acids, in particular those with an even number of carbon atoms, for example erucic acid, lauric acid, palmitic acid and, in particular, C₁₈-fatty acids such as stearic acid, oleic acid, linoleic acid or linolenic acid.

Examples of fatty acid esters such as C₁₀-C₂₂-fatty acid esters are glycerol and glycol esters of fatty acids such as C₁₀-C₂₂-fatty acids or their transesterification products, for example alkyl esters of fatty acids such as C₁-C₂₀-alkyl esters of C₁₀-C₂₂-fatty acids, as can be obtained for example by transesterification of the abovementioned glycerol or glycol fatty acid esters such as C₁₀-C₂₂-fatty acid esters with C₁-C₂₀-alcohols (for example methanol, ethanol, propanol or butanol). The transesterification can be effected by known methods as are described, for example, in Römpp Chemie Lexikon, 9th edition, volume 2, page 1343, Thieme Verlag Stuttgart.

Preferred fatty acid esters are, for example, oils from oil-yielding plant species, such as soya oil, rapeseed oil, corn oil, sunflower oil, cottonseed oil, linseed oil, coconut oil, palm oil, safflower oil, walnut oil, peanut oil, olive oil or castor oil, in particular rapeseed oil, the vegetable oils also being understood as meaning their transesterification products, for example alkyl esters, such as rapeseed oil methyl ester or rapeseed oil ethyl ester.

Examples of dicarboxylic esters and polycarboxylic esters are the full esters of oxalic acid, malonic acid, succinic acid, glutaric acid, adipic acid, pimelic acid, sebacic acid, azelaic acid, suberic acid, maleic acid, phthalic acid, terephthalic acid, mellithic acid, trimellithic acid and polymaleic acid, in particular the C₁-C₁₀-alkyl esters such as the methyl esters, ethyl esters, propyl esters, such as n-propyl esters or iso-propyl esters, butyl esters such as n-butyl esters, iso-butyl esters, sec-butyl esters or tert-butyl esters.

Other suitable carboxylic acid amides are N,N-di(C₁-C₂₀-alkyl)-C₁-C₂₆-carboxamides, for example N,N-dimethyl-C₁-C₂₆-carboxamides, such as N,N-dimethylformamide or N,N-dimethylacetamide, or inner amides such as lactams, for example pyrrolidones, such as N-substituted C₁-C₁₂-alkylpyrrolidones, such as N-methylpyrrolidone, N-butylpyrrolidone, N-octylpyrrolidone, N-dodecylpyrrolidone and N-cyclohexylpyrrolidone.

Suitable phosphoric esters are, for example, triesters of phosphoric acid with alcohols, the alcohols preferably being selected from the group consisting of

1) monohydric alkanols having 1 to 22 carbon atoms, for example n-, i- or neo-pentanol, n-hexanol, n-octanol, 2-ethylhexanol,

2) diols or polyols, such as ethylene glycol, propylene glycol or glycerol,

3) aryl-, alkylaryl-, poly(alkyl)aryl- and poly(arylalkyl)aryl alcohols, for example phenol and/or cresol, octylphenol, nonylphenol, triisobutylphenol, tristyrylphenol,

4) alkoxylated alcohols which are obtained by reacting the alcohols mentioned above under 1), 2) or 3) with alkylene oxides, preferably (C₁-C₄)alkylene oxides.

Preferred phosphoric esters are triesters of ortho-phosphoric acid, in particular alkoxylated triesters of ortho-phosphoric acid, such as tri(butyoxyethyl) phosphate.

Suitable ketones are, for example, aromatic, cycloaliphatic or aliphatic ketones, such as acetophenone, benzophenone, isophorone, cyclohexanone and methyl ethyl ketone, ethyl butyl ketone, diethyl ketone, dibutyl ketone.

Suitable ethers are, for example, aromatic, cycloaliphatic or aliphatic ethers, such as anisole, tetrahydrofuron, oxirane, dibutyl ether, dipentyl ether, butyl hexyl ether, methyl tert-buthyl ether.

Preferred nonalcoholic solvents b) are aromatic hydrocarbons such as C₁-C₆-alkylbenzenes, for example toluene or xylene, C₁-C₆-alkylnaphthalenes and mixtures of aromatic hydrocarbons such as the Solvesso®) series from Exxon, ketones such as acetophenone, isophorone, cyclohexanone and methyl ethyl ketone, N-substituted C₁-C₁₂-alkylpyrrolidones such as N-methylpyrrolidone, N-butylpyrrolidone, N-octylpyrrolidone, N-dodecylpyrrolidone and N-cyclohexylpyrrolidone, cyclic aliphatic hydrocarbons such as decalin and cyclohexane, acid amides such as dimethylformamide, dimethyl sulfoxide, lactones such as gamma-butyrolactone, di- or polycarboxylic esters such as C₁-C₁₂-alkyl esters of phthalic acid, adipic esters, for example diisopropyl adipate, dimethyl adipate and diisobutyl adipate, and fatty acid esters.

Suitable as anionic surfactants c) are, for example, sulfates, sulfonates, phosphates and phosponates of hydrocarbons which may optionally comprise alkylene oxide units. The sulfates, sulfonates, phosphates and phosponates can exist in acid form or as salts. Preferred anionic surfactants c) are those of the formula (I) hereinbelow:

R—Q (I)

in which

Q is —O—SO₃ M, —SO₃ M, —O—PO₃H M or PO₃H M, where M is H or a cation, in particular a metal cation such as an alkali metal ion or alkaline earth metal ion, or an ammonium ion,

R is an unsubstituted or substituted C₁-C₃₀-hydrocarbon radical which can optionally be bonded via alkylene oxide units, or R is an alkylene oxide unit.

The term alkylene oxide units is understood as meaning in particular units of C₂-C₁₀-alkylene oxides, such as ethylene oxide, propylene oxide or butylene oxide, it being possible for the units within the surfactant to be identical or different from one another and to be arranged as a random mixture or blockwise.

R is preferably a C₁-C₂₀-alkyl radical (for example methyl, ethyl, propyl, butyl) or a C₆-C₂₄-aryl radical (for example phenyl, biphenyl, naphthyl) which can optionally have attached to it one or more radicals, for example from the C₁-C₂₀-alkyl group (for example linear or branched C₁-C₂₀-alkyl such as sec-butyl or dodecyl) which can have attached to it one or more radicals such as C₆-C₂₀-aryl radicals (for example phenyl, biphenyl, naphthyl), and C₆-C₂₀-aryl (for example phenyl, biphenyl or naphthyl) which can optionally have attached to it one or more radicals such as C₁-C₁₀-alkyl (for example methyl, ethyl, propyl, butyl), or

R is a radical R²O—(AO)_{w}, where w is an integer from 1 to 100 and AO is an alkylene oxide unit, for example (EO)_{X}(PO)_{Y}(BO)_{Z}, where EO is an ethylene oxide unit, PO a propylene oxide unit, BO a butylene oxide unit, x an integer from 0-100, y an integer from 0-100, z an integer from 0 to 100 and the total x+y+z is at least 1, and the alkylene oxide unit, for example (EO)_{X}(PO)_{Y}(BO)_{Z}, can be arranged randomly or blockwise, and

R² is H, a C₁-C₂₀-alkyl radical (for example methyl, ethyl, propyl, butyl) or a C₆-C₂₄-aryl radical (for example phenyl, biphenyl, naphthyl), which can optionally have attached to it one or more radicals, for example from the C₁-C₂₀-alkyl group (for example linear or branched C₁-C₂₀-alkyl such as sec-butyl or dodecyl) which can have attached to it one or more radicals such as C₆-C₂₀-aryl radicals (for example phenyl, biphenyl, naphthyl), and C₆-C₂₀-aryl (for example phenyl, biphenyl or naphthyl) which can optionally have attached to it one or more radicals such as C₁-C₁₀-alkyl (for example methyl, ethyl, propyl, butyl), or R² is —O—SO₃M, —SO₃M, —O—PO₃HM, H or PO₃H M, preferably PO₃H M, where M equals H or a cation, in particular a metal cation such as an alkali metal ion or alkaline earth metal ion, or an ammonium ion.

Especially preferred anionic surfactants c) are alkylarylsulfonates such as dodecylbenzenesulfonates, for example alkaline earth metal dodecylbenzenesulfonates such as calcium dodecylbenzenesulfonates (for example Phenylsulfonat® Ca100 by Clariant), alkylarylpolyglycol ether sulfates and sulfonates, in particular arylalkylaryl polyglycol ether sulfates such as tristyrylphenyl polyglycol ether sulfates, in particular the alkali metal or ammonium or triethanolamine salts (for example Soprophore® series by Rhodia), alkyl ether sulfates and their salts (for example such as Genapol® LRO by Clariant), alkyl sulfates and alkylsulfonates (for example such as the Hostapur® series by Clariant), alkyl polyglycol ether phosphates, in particular the alkali metal salts (for example the Rhodafac® series Rhodia), alkylaryl polyglycol ether phosphates, in particular in the form of the alkali metal salts. In general, the salts are preferably metal salts such as alkali or alkaline earth metal salts or ammonium or trialkylamine salts.

Suitable nonionic surfactants d) are, for example, alkoxylates, for example ethoxylates, propoxylates or butoxylates and their combinations. The term alkoxylates is understood as meaning compounds comprising alkylene oxide units, in particular units of C₂-C₁₀-alkylene oxides, such as ethylene oxide, propylene oxide or butylene oxide, it being possible for the units within the surfactant to be identical or different from one another and arranged randomly or blockwise. Examples of alkoxylates d) are compounds of the formula (II) hereinbelow:

R¹—(AO)_{w}—R² (II)

in which

R¹ is selected from the group H, HO, C₁-C₃₀-alkyl, which can be linear or branched (for example methyl, ethyl, propyl, butyl, pentyl, hexyl), C₁-C₃₀-alkoxy, preferably C₁-C₁₀-alkoxy, which can be linear or branched (for example methoxy, ethoxy, propoxy, butoxy, pentoxy, hexoxy), C₆-C₂₄-aryl (for example phenyl), which can optionally have attached to it one or more radicals such as C₁-C₃₀-arylalkyl (for example styrylphenyl) or C₁-C₃₀-alkyl, in which the alkyl groups can be linear or branched (for example butyl or dodecyl), C₆-C₂₄-aryloxy (for example phenoxy), which can optionally have attached to it one or more radicals such as C₁-C₃₀-arylalkyl (for example styrylphenyl), or C₁-C₃₀-alkyl, in which the alkyl groups can be linear or branched (for example butyl or dodecyl), or

R¹ is a sorbitan ester residue, a glycerol ester residue or C₁-C₃₀-alkyl-NR⁴, preferably C₁₀-C₂₀-alkyl-NR⁴, in which the C₁-C₂₀-alkyl group can be linear or branched (for example dodecyl, hexadecyl, octadecyl) and in which R⁴ equals H or C₁-C₁₀-alkyl (for example methyl, ethyl, propyl, butyl),

R² equals H or C₁-C₆-alkyl which can be linear or branched (for example methyl, ethyl, propyl, butyl, pentyl or hexyl), and

w is an integer from 1 to 100, AO is an alkylene oxide unit, for example (EO)_{X}(PO)_{Y}(BO)_{Z}, where EO is an ethylene oxide unit, PO a propylene oxide unit, BO a butylene oxide unit, x an integer from 0-100, y an integer from 0-100, z an integer from 0 to 100 and the total x+y+z is at least 1, and the alkylene oxide unit, for example (EO)_{X}(PO)_{Y}(BO)_{Z}, has a random or blockwise structure.

Especially preferred nonionic surfactants d) are alkylaryl polyalkoxylates, for example the ethoxylates, propoxylates and/or butoxylates, arylalkylaryl polyalkoxylates such as tristyrylphenyl polyalkoxylates (for example Soprophor® series by Rhodia) and alkylphenyl polyalkoxylates such as tributylphenyl polyalkoxlates (for example Sopagenat® series by Clariant), alkylene oxide block copolymers such as ethylene oxide (EO)/propylene oxide (PO) block copolymers or ethylene oxide (EO)/butylene oxide (BO) block copolymers (for example Pluronic® series by BASF), polyalkylene oxides such as polyethyene oxides, polypropylene oxides or polybutylene oxides, optionally substituted at one of the two terminal oxygen atoms by C₁-C₂₂-hydrocarbon radicals, preferably C₁₀-C₂₂-hydrocarbon radicals such as straight-chain or branched C₁₀-C₂₂-alkyl radicals (for example decyl, dodecyl, tetradecyl, hexadecyl), for example polyglycol ethers which can be substituted by isotridecyl (for example Genapol® series by Clariant), alkoxylated, such as ethoxylated, oils such as vegetable oils, for example alkoxylated, such as ethoxylated, castor oil (Emulsogen® series Clariant), alkoxylated, such as ethoxylated, (C₁₀-C₂₂)-fatty amines (for example Genamin® series by Clariant).

When the present description mentions carbon-containing radicals, such as alkyl, alkoxy, haloalkyl, haloalkoxy, alkylamino and alkylthio, and the corresponding unsaturated and/or substituted radicals, their carbon skeleton can be straight-chain or branched in each case. Unless mentioned otherwise, these radicals generally have 1 to 30 carbon atoms, the lower carbon skeletons, for example those having 1 to 6 carbon atoms, or, in the case of unsaturated groups, 2 to 6 carbon atoms, being preferred. Alkyl radicals, also in the composite meanings such as alkoxy, haloalkyl and the like, are, for example, methyl, ethyl, n- or i-propyl, n-, i-, t- or sec-butyl, pentyls, hexyls, such as n-hexyl, i-hexyl and 1,3-dimethylbutyl, heptyls, such as n-heptyl, 1-methylhexyl and 1,4-dimethylpentyl; alkenyl and alkynyl radicals have the meaning of the possible unsaturated radicals which correspond to the alkyl radicals; for example, alkenyl is allyl, 1-methylprop-2-en-1-yl, 2-methylprop-2-en-1-yl, but-2-en-1-yl, but-3-en-1-yl, 1-methylbut-3-en-1-yl and 1-methylbut-2-en-1-yl; alkynyl is, for example, propargyl, but-2-yn-1-yl, but-3-yn-1-yl, 1-methylbut-3-yn-1-yl.

Alkenyl in the form (C₃-C₄)alkenyl, (C₃-C₅)alkenyl, (C₃-C₆)alkenyl, (C₃-C₈)alkenyl or (C₃-C₁₂)-alkenyl is preferably an alkenyl radical having 3 to 4, 3 to 5, 3 to 6, 3 to 8 or 3 to 12 carbon atoms in which the double bond is not located at the carbon atom which is linked to the remaining moiety of the compound of the formula (I) (“yl” position). This also applies analogously to (C₃-C₄)alkynyl and the like, (C₃-C₄)alkenyloxy and the like and (C₃-C₄)alkynyloxy and the like.

A hydrocarbon radical means a straight-chain, branched or cyclic and saturated or unsaturated aliphatic or aromatic hydrocarbon radical, for example alkyl, alkenyl, alkynyl, cycloalkyl, cycloalkenyl or aryl.

A hydrocarbon radical preferably has 1 to 40 carbon atoms, with preference 1 to 30 carbon atoms; a hydrocarbon radical is especially preferably alkyl, alkenyl or alkynyl having up to 12 carbon atoms or cycloalkyl having 3, 4, 5, 6 or 7 ring atoms or phenyl.

Aryl means a mono-, bi- or polycyclic aromatic system, for example phenyl, naphthyl, tetrahydronaphthyl, indenyl, indanyl, pentalenyl, fluorenyl and the like, preferably phenyl.

A heterocyclic radical or ring (heterocyclyl) can be saturated, unsaturated or heteroaromatic and unsubstituted or substituted; it preferably contains one or more hetero atoms in the ring, preferably from the group consisting of N, O and S; it is preferably an aliphatic heterocyclyl radical having 3 to 7 ring atoms or a heteroaromatic radical having 5 or 6 ring atoms and contains 1, 2 or 3 hetero atoms. The heterocyclic radical can be for example a heteroaromatic radical or ring (heteroaryl), such as, for example, a mono-, bi- or polycyclic aromatic system in which at least 1 ring contains one or more hetero atoms, for example pyridyl, pyrimidinyl, pyridazinyl, pyrazinyl, triazinyl, thienyl, thiazolyl, oxazolyl, furyl, pyrrolyl, pyrazolyl and imidazolyl, or it is a partially or fully hydrogenated radical such as oxiranyl, oxetanyl, pyrrolidyl, piperidyl, piperazinyl, dioxolanyl, morpholinyl, tetrahydrofuryl. Suitable substituents for a substituted heterocyclic radical are the substituents mentioned further below, and additionally also oxo. The oxo group can also be present at those hetero ring atoms which may exist at various levels of oxidation, for example in the case of N and S.

Halogen is, for example, fluorine, chlorine, bromine or iodine. Haloalkyl, -alkenyl and -alkynyl are alkyl, alkenyl or alkynyl which is partially or fully substituted by halogen, preferably by fluorine, chlorine and/or bromine, in particular by fluorine or chlorine, for example CF₃, CHF₂, CH₂F, CF₃CF₂, CH₂FCHCl, CCl₃, CHCl₂, CH₂CH₂Cl; haloalkoxyl is, for example, OCF₃, OCHF₂, OCH₂F, CF₃CF₂O, OCH₂CF₃ and OCH₂CH₂Cl; this also applies analogously to haloalkenyl and other halogen-substituted radicals.

Hydrocarbon radicals, for example alkyl, alkenyl, alkynyl, aryl, phenyl and benzyl, or heterocyclyl or heteroaryl can be substituted, the substituents meaning, for example, one or more, preferably 1, 2 or 3, radicals from the group consisting of halogen, alkoxy, haloalkoxy, alkylthio, hydroxyl, amino, nitro, carboxyl, cyano, azido, alkoxycarbonyl, alkylcarbonyl, formyl, carbamoyl, mono- and dialkylaminocarbonyl, substituted amino such as acylamino, mono- and dialkylamino, and alkylsulfinyl, haloalkylsulfinyl, alkylsulfonyl, haloalkylsulfonyl and, in the case of cyclic radicals, also alkyl and haloalkyl and unsaturated aliphatic radicals which correspond to the abovementioned saturated hydrocarbon-containing radicals, such as alkenyl, alkynyl, alkenyloxy, alkynyloxy and the like. In the case of radicals with carbon atoms, those having 1 to 4 carbon atoms, in particular 1 or 2 carbon atoms, are preferred. Preferred substituents are, as a rule, those from the group consisting of halogen, for example fluorine and chlorine, (C₁-C₄)alkyl, preferably methyl or ethyl, (C₁-C₄)haloalkyl, preferably trifluoromethyl, (C₁-C₄)alkoxy, preferably methoxy or ethoxy, (C₁-C₄)haloalkoxy, nitro and cyano. Especially preferred in this context are the substituents methyl, methoxy and chlorine.

Optionally substituted phenyl is preferably phenyl which is unsubstituted or mono- or polysubstituted, preferably up to trisubstituted, by identical or different radicals from the group consisting of halogen, (C₁-C₄)alkyl, (C₁-C₄)alkoxy, (C₁-C₄)halogenoalkyl, (C₁-C₄)halogenoalkoxy and nitro, for example o-, m- and p-tolyl, dimethylphenyls, 2-, 3- and 4-chlorophenyl, 2-, 3- and 4-trifluoro- and -trichlorophenyl, 2,4-, 3,5-, 2,5- and 2,3-dichlorophenyl, o-, m- and p-methoxyphenyl.

An acyl radical means the radical of an organic acid which is formed formally by eliminating an OH group from the organic acid, for example a carboxylic acid radical and radicals of acids derived from it such as thiocarboxylic acid, optionally N-substituted iminocarboxylic acids or the radicals of carbonic monoesters, optionally N-substituted carbamic acids, sulfonic acids, sulfinic acids, phosphonic acids and phosphinic acids.

An acyl radical is preferably formyl or aliphatic acyl from the group consisting of CO—R^{x}, CS—R^{x}, CO—OR^{x}, CS—OR^{x}, CS—SR^{x}, SOR^{Y} or SO₂R^{Y}, where R^{x} and R^{Y} in each case denotes a C₁-C₃₀-hydrocarbon radical which is unsubstituted or substituted, or aminocarbonyl or aminosulfonyl, the two last-mentioned radicals being unsubstituted, N-monosubstituted or N,N-disubstituted.

Acyl is, for example, formyl, halogenoalkylcarbonyl, alkylcarbonyl such as (C₁-C₄)alkylcarbonyl, phenylcarbonyl, it being possible for the phenyl ring to be substituted, for example as stated above for phenyl, or alkyloxycarbonyl, phenyloxycarbonyl, benzyloxycarbonyl, alkylsulfonyl, alkylsulfinyl, N-alkyl-1-iminoalkyl and other radicals of organic acids.

The formula (I) and the other compounds mentioned in the present description also encompass all of the stereoisomers and their mixtures. Such compounds contain one or more asymmetric carbon atoms or else double bonds which are not mentioned specifically in the general formula. The possible stereoisomers, which are defined by their specific spatial shape, such as enantiomers, diastereomers, Z- and E-isomers, are all encompassed by the respective formulae and can be obtained from mixtures of the stereoisomers by customary methods or else be prepared by stereoselective reactions in combination with the use of stereochemically pure starting materials.

The microemulsion concentrates according to the invention can be prepared by customary methods, for example mixing by dissolving or emulsifying the individual components, preferably at room temperature. If further auxiliaries and additives are present, they are likewise preferably introduced at room temperature. In general, the individual components can be added in any desired sequence.

The preparation processes are known in principle and are described, for example, in Winnacker-Küichler, “Chemische Technologie” [Chemical Technology], volume 7, C. Hauser Verlag Munich, 4th Ed. 1986, Wade van Valkenburg, “Pesticide Formulations”, Marcel Dekker, New York, 1973; K. Martens, “Spray Drying” Handbook, 3^{rd} Ed. 1979, G. Goodwin Ltd. London; H. Mollet, A. Grubenmann, “Formulierungstechnik” [Formulation Technology], Wiley-VCH, Weinheim 2000.

The formulation auxiliaries, such as inert materials and further additives, are likewise known and are described, for example, in: Watkins, “Handbook of Insecticide Dust Diluents and Carriers”, 2nd Ed., Darland Books, Caldwell N.J., H. v. Olphen, “Introduction to Clay Colloid Chemistry”; 2nd Ed., J. Wiley & Sons, New York; C. Marsden, “Solvents Guide”; 2nd Ed., Interscience, New York 1963; McCutcheon's “Detergents and Emulsifiers Annual”, MC Publ. Corp., Ridgewood N.J.; Sisley and Wood, “Encyclopedia of Surface Active Agents”, Chem. Publ. Co. Inc., New York 1964; Schönfeldt, “Grenzflächenaktive Äthylenoxidaddukte” [Surface-active ethylene oxide adducts], Wiss. Verlagsgesell., Stuttgart 1976; Winnacker-Küichler, “Chemische Technologie”, volume 7, C. Hauser Verlag Munich, 4th Ed. 1986.

Based on these formulations, it is also possible to prepare combinations with agrochemical active ingredients other than component a), such as herbicides, fungicides, insecticides, safeners, fertilizers and/or growth regulators, for example in the form of a ready mix or a tank mix.

The microemulsion concentrates according to the invention can be diluted with water to give microemulsions which are likewise subject matter of the present invention. The weight ratio microemulsion concentrate:water can be, for example, 1:0.1 to 1:100, preferably 1:1 to 1:100, which gives concentrated microemulsions which, per se, are storage stable. For application purposes, they can be diluted further with water to give spray mixtures which are generally present in the form of emulsions such as microemulsions, aqueous solutions, suspensions or suspoemulsions.

Components a), b), c) and d) of the microemulsion concentrates and microemulsions according to the invention may be present together in a ready mix which can then be applied in the customary manner, for example in the form of a spray mixture.

In addition to components a), b), c) and d), the microemulsion concentrates and microemulsions according to the invention, including the spray mixtures which can be obtained from them (hereinbelow all referred to as agrochemical compositions according to the invention), may additionally comprise as further component customary auxiliaries and additives, for example formulation auxiliaries such as anti-drift agents, humectants, fertilizers such as ammonium sulfate, urea or compound fertilizers, for example on a phosphorus, potassium and nitrogen basis, such as P,K,N fertilizers, or commercially available surfactants other than components c) and d), such as betainic or polymeric surfactants, stabilizers such as pH stabilizers, biocides, UV stabilizers, antifoams, synthetic or natural polymers, solvents, for example polar solvents such as water or unpolar solvents such as saturated or unsaturated aliphatic solvents which can be branched or unbranched, or aromatic solvents such as Solvesso®100, Solvesso®150 or Solvesso®) 200 or xylene. These agrochemical compositions and their preparation and use are likewise novel and subject matter of the present invention.

Preferred examples of customary auxiliaries and additives are

wetters such as Genapol® LRO (0-20% by weight), dispersants such as Tamol® (0-15% by weight) or further surfactants (nonionic, cationic, anionic, polymeric surfactants) (0-30% by weight);

inorganic salts such as NaCl, Na₂SO₄, MgCl₂ (0-50% by weight), (oligo-, poly-) phosphates; carbonates such as potassium carbonate;

fertilizers such as ammonium sulfate, ammonium nitrate, urea, phosphorus- and potassium-containing components, if appropriate further trace elements (0-60% by weight);

antifoams such as Fluowet® PP (0-2% by weight);

binders such as suitable natural or synthetic substances such as polyamino acids, polyvinyl alcohols, polyvinylpyrrolidone, polyacrylic acid derivatives, (0-15% by weight); or

solvents such as water or organic solvents (0-15% by weight).

The agrochemical compositions according to the invention can be employed for example by application to the harmful organisms or the locations where they occur, for example by spraying. As a rule, the agrochemical compositions according to the invention are applied in the form of a spray mixture which comprises the components a), b), c) and d) in effective amounts and, if appropriate, further customary auxiliaries and additives, for example for formulation or use. In general, the spray mixture is prepared on the basis of water, it being possible to add customary auxiliaries and additives, for example oils, such as vegetable oils, or high-boiling hydrocarbons, such as kerosene or paraffin.

Upon application, the concentration of agrochemical active ingredient a) is generally 10⁻⁶ to 10% by weight, preferably 10⁻⁵ to 4% by weight in the applied composition, for example the spray mixture, at an application rate of 1 to 5 000 I/ha, preferably 50 to 1 000 I/ha.

For use, concentrated formulations which are present in commercially available form are, if appropriate, diluted in the customary manner, for example by means of water. It may be advantageous to add further amounts of components b), c) and d) and/or other conventional auxiliaries and additives for use, in particular self-emulsifying oils or paraffin oils, to the spray mixtures. Additional components a) or other agrochemical active ingredients other than component a) may also be added.

The application rate required of the agrochemical active ingredients a) can vary with the external conditions such as temperature, humidity, type of herbicide used. It can vary within wide limits, for example between 0.001 and 10 kg/ha or more active substance; it is preferably between 0.005 and 5 kg/ha.

The agrochemical compositions according to the invention are preferably herbicidal compositions. They have an outstanding herbicidal activity against a broad spectrum of economically important monocotyledonous and dicotyledonous harmful plants. The active ingredients also act efficiently on perennial weeds which produce shoots from rhizomes, rootstocks or other perennial organs and which are difficult to control. In this context, the substances can be applied for example before sowing, pre-emergence or post-emergence. Specific examples may be mentioned of some representatives of the monocotyledonous and dicotyledonous weed flora which can be controlled by the herbicidal compositions according to the invention, without the enumeration being a restriction to certain species.

Examples of weed species on which the herbicidal compositions act efficiently are, from amongst the monocotyledonous weed species, for example Apera spica venti, Avena spp., Alopecurus spp., Brachiaria spp., Digitaria spp., Lolium spp., Echinochloa spp., Panicum spp., Phalaris spp., Poa spp., Setaria spp. and Bromus spp. such as Bromus catharticus, Bromus secalinus, Bromus erectus, Bromus tectorum and Bromus japonicus and Cyperus species from the annual group and, among the perennial species, Agropyron, Cynodon, Imperata and Sorghum and also perennial Cyperus species.

In the case of dicotyledonous weed species, the spectrum of action extends to species such as, for example, Abutilon spp., Amaranthus spp., Chenopodium spp., Chrysanthemum spp., Galium spp. such as Galium aparine, Ipomoea spp., Kochia spp., Lamium spp., Matricaria spp., Pharbitis spp., Polygonum spp., Sida spp., Sinapis spp., Solanum spp., Stellaria spp., Veronica spp. and Viola spp., Xanthium spp., amongst the annuals, and Convolvulus, Cirsium, Rumex and Artemisia in the case of the perennial weeds.

The active ingredients according to the invention also act outstandingly efficiently on harmful plants which are found under the specific cultures in rice, such as, for example, Echinochloa, Sagittaria, Alisma, Eleocharis, Scirpus and Cyperus.

If the herbicidal compositions according to the invention are applied to the soil surface before germination, the weed seedlings are either prevented completely from emerging or else the weeds grow until they have reached the cotyledon stage, but then their growth stops, and, eventually, after three to four weeks have elapsed, they die completely.

If the herbicidal compositions according to the invention are applied post-emergence to the green parts of the plants, growth likewise stops drastically a very short time after the treatment, and the weed plants remain at the growth stage of the point of time of application, or they die completely after a certain time, so that in this manner competition by the weeds, which is harmful to the crop plants, is eliminated very early and in a sustained manner.

The herbicidal compositions according to the invention are distinguished by a rapid onset and long duration of the herbicidal activity. As a rule, the rainfastness of the active ingredients in the combinations according to the invention is favorable. A particular advantage is that the dosages of herbicidal compounds which are used in the herbicidal compositions and which are effective can be adjusted to such a low level that their soil action is optimally low. This means that not only is their use in sensitive crops made possible in the first place, but groundwater contaminations are virtually avoided. The combination according to the invention of active ingredients makes possible a considerable reduction of the required application rate of the active ingredients.

The abovementioned properties and advantages are useful in weed control practice in order to keep agricultural crops free from undesired plant competition and thus qualitatively and quantitatively to safeguard and/or increase the yields. The state of the art is considerably surpassed by these novel compositions with regard to the above-described properties.

Even though the herbicidal compositions according to the invention have an outstanding herbicidal activity against monocotyledonous and dicotyledonous weeds, crop plants of economically important crops, for example of dicotyledonous crops such as soya, cotton, oilseed rape, sugar beet, or Gramineae crops such as wheat, barley, rye, oats, sorghum and millet, rice or maize, are harmed only to a minor extent, if at all. For these reasons, the present compounds are highly suitable for the selective control of undesired vegetation in plantations of agriculturally useful plants or of ornamentals.

In addition, the herbicidal compositions according to the invention have outstanding growth-regulatory properties in crop plants. They engage in the plants' metabolism in a regulatory manner and can thus be employed for influencing plant constituents in a specific manner and for facilitating harvesting, such as, for example, by triggering desiccation and stunted growth. Moreover, they are also suitable for generally controlling and inhibiting undesired vegetative growth without simultaneously destroying the plants. Inhibiting vegetative growth plays an important role in a number of monocotyledonous and dicotyledonous crops since lodging can thus be reduced or prevented completely.

Owing to their herbicidal and plant-growth-regulatory properties, the herbicidal compositions according to the invention can also be employed for controlling harmful plants in crops of genetically modified plants which are known or yet to be developed. As a rule, the transgenic plants are distinguished by particular advantageous properties, for example by resistances to certain pesticides, especially certain herbicides, resistances to plant diseases or to plant pathogens such as certain insects or microorganisms such as fungi, bacteria or viruses. Other particular properties concern for example the harvested material with regard to quantity, quality, storability, composition and specific constituents. Thus, transgenic plants with an increased starch content or with a modified starch quality or with a different fatty acid composition of the harvested material are known.

The use of the herbicidal compositions according to the invention in economically important transgenic crops of useful plants and ornamentals, such as of Gramineae crops such as wheat, barley, rye, oats, sorghum and millet, rice and maize or else crops of sugar beet, cotton, soybean, oilseed rape, potato, tomato, pea and other vegetables is also possible. The compositions according to the invention may preferably be employed as herbicides in crops of useful plants which are resistant to the phytotoxic effects of the herbicides or which have been rendered resistant to the phytotoxic effects of the herbicides by recombinant means.

When the herbicidal compositions according to the invention are used in transgenic crops, effects are frequently observed, in addition to the effects against harmful plants observed in other crops, which are specific for the application in the transgenic crop in question, for example a modified or specifically extended weed spectrum which can be controlled, altered application rates which can be employed for application, preferably good combining properties with the herbicides to which the transgenic crop is resistant, and an effect on growth and yield of the transgenic crop plants.

Subject of the invention is furthermore also a method for controlling undesired vegetation, preferably in crops of plants such as cereals (for example wheat, barley, rye, oats, rice, maize, sorghum and millet), sugar beet, sugar cane, oilseed rape, cotton and soybeans, especially preferably in monocotyledonous crops such as cereals, for example wheat, barley, rye, oats, crosses of these such as triticale, rice, maize, sorghum and millet, wherein the herbicidal composition according to the invention is applied to the harmful plants, plant parts, plant seeds or the area on which the plants grow, for example the area under cultivation, for example pre-emergence, post-emergence or pre- and post-emergence, preferably pre-emergence.

The crops of plants can also have been genetically modified or obtained by the selection of mutants, and are preferably tolerant to acetolactate synthase (ALS) inhibitors.

Subject matter of the invention is also the use of the herbicidal compositions according to the invention for controlling harmful plants, preferably in crops of plants. A preferred use relates to the application of herbicidal compositions comprising synergistic amounts of components a), b), c) and d).

The herbicidal compositions according to the invention can also be employed nonselectively for controlling undesired vegetation, for example in plantation crops, on verges, open places, industrial terrain or railway installations.

The agrochemical compositions, in particular herbicidal compositions, according to the invention may, if appropriate, be present in the form of mixed formulations together with further agrochemical active ingredients and customary auxiliaries and additives, and these mixed formulations are then applied in the customary manner as a dilution with water, or else be prepared in the form of what are known as tank mixes by jointly diluting the separately formulated, or partially separately formulated, components with water.

Owing to the relatively low application rate of the herbicidally compositions according to the invention, they are generally very well tolerated. In particular, a reduction of the absolute application rate, in comparison with the individual use of a herbicidal active ingredient, is achieved by the combinations according to the invention.

The invention therefore also relates to a method for the selective control of harmful plants in crops of plants, which comprises applying a herbicidally active amount of the abovementioned herbicides a) in combination with the components b), c) and d), for example pre-emergence, post-emergence or pre- and post-emergence, preferably pre-emergence, to the plants, plant parts, plant seeds or the area on which the plants grow, for example the area under cultivation.

In a preferred variant of the method, the herbicides a) are applied in application rates of from 0.1 to 2 000 g of active substance/ha, preferably 0.5 to 1 000 g of active substance/ha. Furthermore especially preferred is the application of the active ingredients in the form of a coformulation or in the form of tank mixes, where the individual components, for example in the form of formulations, are jointly mixed with water in the tank and the resulting spray mixture is applied.

Since the crop plant tolerance of the combinations according to the invention is very good while simultaneously providing a very high level of control of the harmful plants, these combinations can be considered as selective. In a preferred variant of the method, herbicidal compositions with the active ingredient combinations according to the invention are therefore employed for selectively controlling undesired plants.

If it is desired to increase the tolerance and/or selectivity of the herbicidal compositions according to the invention even further, it may be advantageous to employ them concomitantly with safeners or antidotes, either jointly as a mixture or staggered in time one after the other.

Compounds which are suitable as safeners or antidotes for the herbicidal compositions according to the invention are known, for example, from EP-A-333 131 (ZA-89/1960), EP-A-269 806 (U.S. Pat. No. 4,891,057), EP-A-346 620 (AU-A-89/34951) and the international patent applications PCT/EP 90/01966 (WO-91108202) and PCT/EP 90102020 (WO-911078474) and references cited therein or can be prepared by the methods described therein. Other suitable safeners are known from EP-A-94 349 (U.S. Pat. No. 4,902,304), EP-A-191 736 (U.S. Pat. No. 4,881,966) and EP-A-0 492 366 and the references cited therein.

In a preferred embodiment, the herbicidal compositions of the present invention therefore comprise an additional content of one or more compounds which act as safeners or antidotes.

Especially preferred antidotes or safeners or groups of compounds which are suitable as safeners or antidotes for the above-described herbicidal compositions of the invention are, inter alia:

a) compounds of the dichlorophenylpyrazoline-3-carboxylic acid type, preferably compounds such as ethyl 1-(2,4-dichlorophenyl)-5-(ethoxycarbonyl)-5-methyl-2-pyrazoline-3-carboxylate (compound S1-1, mefenpyr-diethyl) and related compounds as are described in the international application WO 91/07874 (PCT/EP 90102020);

b) dichlorophenylpyrazolecarboxylic acid derivatives, preferably compounds such as ethyl 1-(2,4-dichlorophenyl)-5-methylpyrazole-3-carboxylate (compound S1-2), ethyl 1-(2,4-dichlorophenyl)-5-isopropylpyrazole-3-carboxylate (compound S1-3), ethyl 1-(2,4-dichlorophenyl)-5-(1,1-dimethylethyl)pyrazole-3-carboxylate (compound S1-4), ethyl 1-(2,4-dichlorophenyl)-5-phenylpyrazole-3-carboxylate (compound S1-5) and related compounds as are described in EP-A-0 333 131 and EP-A-0 269 806;

c) compounds of the triazolecarboxylic acid type, preferably compounds such as ethyl 1-(2,4-dichlorophenyl)-5-trichloromethyl-(1H)-1,2,4-triazole-3-carboxylate (compound S1-6, fenchlorazole) and related compounds (see EP-A-0 174 562 and EP-A-0 346 620);

d) compounds of the dichlorobenzyl-2-isoxazoline-3-carboxylic acid type, compounds of the 5-benzyl- or 5-phenyl-2-isoxazoline-3-carboxylic acid type, preferably compounds such as ethyl 5-(2,4-dichlorobenzyl)-2-isoxazoline-3-carboxylate (compound S1-7) or ethyl 5-phenyl-2-isoxazoline-3-carboxylate (compound S1-8) and related compounds as are described in the international patent application WO 91/08202 (PCT/EP 90/01966);

e) compounds of the 8-quinolinoxyacetic acid type, preferably compounds such as 1-methylhex-1-yl (5-chloro-8-quinolinoxy)acetate (S2-1; cloquintocetmexyl), 1,3-dimethylbut-1-yl (5-chloro-8-quinolinoxy)acetate (S2-2), 4-allyloxybutyl (5-chloro-8-quinolinoxy)acetate (S2-3), 1-allyloxyprop-2-yl (5-chloro-8-quinolinoxy)acetate (S2-4), ethyl (5-chloro-8-quinolinoxy)acetate (S2-5), methyl (5-chloro-8-quinolinoxy)acetate (S2-6), allyl (5-chloro-8-quinolinoxy)acetate (S2-7), 2-(2-propylideneiminoxy)-1-ethyl (5-chloro-8-quinolinoxy)acetate (S2-8), 2-oxoprop-1-yl (5-chloro-8-quinolinoxy)acetate (S2-9) and related compounds as are described in EP-A-0 086 750, EP-A-0 094 349 and EP-A-0 191 736 or EP-A-0 492 366;

f) compounds of the (5-chloro-8-quinolinoxy)malonic acid type, preferably compounds such as diethyl (5-chloro-8-quinolinoxy)malonate, diallyl (5-chloro-8-quinolinoxy)malonate, methyl ethyl (5-chloro-8-quinolinoxy)malonate and related compounds as have been described and proposed in German patent application EP-A-0 582 198;

g) active ingredients of the phenoxyacetic and -propionic acid derivative type or of the aromatic carboxylic acid type such as, for example, 2,4-dichlorophenoxyacetic acid and its esters (2,4-D), 4-chloro-2-methylphenoxypropionic acid (mecoprop), MCPA or 3,6-dichloro-2-methoxybenzoic acid and its esters (dicamba).

h) compounds of the 5,5-diphenyl-2-isoxazoline-3-carboxylic acid type, preferably ethyl 5,5-diphenyl-2-isoxazoline-3-carboxylate (S3-1, isoxadifenethyl).

i) compounds which are known as safeners, for example for rice, such as fenclorim (=4,6-dichloro-2-phenylpyrimidine, Pesticide Manual, 11th edition, 1997, p. 511-512), dimepiperate (=S-1-methyl-1-phenylethyl piperidine-1-carbothioate, Pesticide Manual, 11th edition, 1997, p. 404-405), daimuron (=1-(1-methyl-1-phenylethyl)-3-p-tolylurea, Pesticide Manual, 11th edition, 1997, p. 330), cumyluron (=3-(2-chlorophenylmethyl)-1-(1-methyl-1-phenylethyl)-urea, JP-A-60/087254), methoxyphenone (=3,3′-dimethyl-4-methoxybenzophenone, CSB (=1-bromo-4-(chloromethylsulfonyl)benzene, CAS Reg. No. 54091-06-4).

Moreover, at least some of the abovementioned compounds are described in EP-A-0 640 587, which is herewith incorporated by reference.

j) further important groups of compounds which are suitable as safeners and antidotes are disclosed in WO 95/07897 and WO 99/16744.

The safeners (antidotes) of the above groups a) to j) reduce or prevent phytotoxic effects which may occur when employing the herbicidal compositions according to the invention in crops of useful plants without adversely affecting the activity of the herbicides against harmful plants. This allows the field of application of the herbicidal compositions according to the invention to be widened substantially; in particular, the use of safeners makes possible the application of herbicidal compositions which could previously be employed to a limited extent only, or with insufficient success, i.e. of combinations which, when used without safeners at low dosages, provided insufficient control of the harmful plants and showed little broad-spectrum activity.

The components a), b), c) and d) of the herbicidal compositions according to the invention and the abovementioned safeners can be applied together (for example as ready mixes or by the tank mix method) or one after the other in any desired sequence. The weight ratio safener:herbicide can vary within wide limits and is preferably in the range of from 1:100 to 100:1, in particular 1:100 to 50:1. The amounts of herbicide(s) and safener(s) which are optimal in each case will normally depend on the type of herbicidal composition and/or the safener used and on the nature of the plant stand to be treated.

Depending on their properties, the safeners can be used for pretreating the seed of the crop plant (seed treatment) or by way of pre-plant incorporation or else applied together with the herbicide mixture before or after plant emergence. Pre-emergence treatment includes not only the treatment of the area under cultivation prior to sowing, but also the treatment of the areas under cultivation where seed has been sown, but has not yet emerged. The joint application together with the herbicide mixture is preferred. Tank mixes or ready mixes can be employed for this purpose.

Depending on the indication and the herbicide used, the safener application rates required can vary within wide limits; as a rule, they are in the range of from 0.001 to 1 kg, preferably 0.005 to 0.2 kg of active ingredient per hectare.

The herbicidal compositions according to the invention can be applied in the customary manner, for example with water as carrier in spray mixture rates of approximately 5 to 4 000 liters/ha. Likewise the compositions can be applied by what are known as the low-volume and ultra-low-volume methods (ULV).

In addition, the herbicidal compositions of the invention may also comprise one, two or more agrochemical active ingredients other than the herbicides a) (for example insecticides, fungicides, safeners), usually in minor amounts, in order to complement the property profile.

This results in a large number of possibilities for combining a plurality of agrochemical active ingredients with one another and for employing them jointly for controlling harmful organisms such as harmful plants in crops of plants, without deviating from the spirit of the invention.

In one embodiment, for example, a variety of agrochemical active ingredients can be combined with one another, for example fenoxaprop-p-ethyl/ioxynil-octanoate, diclofop/bromoxynil-octanoate, CMPP/bromoxynil-octanoate, MCPA/ioxynil-octanoate, bromoxynil-octanoate/bromoxynil-heptanoate, bromoxynil-octanoate/bromoxynil-heptanoate/MCPA, bromoxynil-octanoate/bromoxynil-heptanoate/2,4-D, phenmedipham/desmedipham, phenmedipham/desmedipham/ethofumesate, metamitron/ethofumesate, phenmedipham/ethofumesate/metamitron, fenoxaprop-p-ethyl/iodosulfuron-methyl-sodium, deltametrin/cypermetrin.

The herbicidal active ingredients a) and their mixtures, for example the abovementioned active ingredient mixtures, can be combined with one or more safeners, in particular with the safeners mefenpyr-diethyl (S1-1), cloquintocet-mexyl (S2-1), isoxadifen-ethyl (S3-1) or fenchlorazol-ethyl (S1-6), preferably with (S1-1), (S2-1) or (S3-1).

Surprisingly, the microemulsion concentrates according to the invention give stable microemulsions upon dilution with water without the use of alcoholic solvent.

The microemulsion concentrates and microemulsions according to the invention show an advantageous physical application behavior. During the application, the agrochemical active ingredient remains uniformly distributed in the spray tank, making possible a uniform application to the crop or area under cultivation. Even mixtures formed in the spray tank (tank mixes) such as aqueous solutions, suspensions, emulsions or suspoemulsions are stable.

The agrochemical compositions according to the invention have an outstanding biological activity and preferably act synergistically. These effects permit, inter alia, the application rate to be reduced, a broader spectrum of harmful organisms to be controlled, gaps in the control to be overcome, a more rapid and reliable activity, an extended long-term activity, complete control of the harmful organisms with only one or few applications, and the application window to be widened.

The use examples which follow illustrate the invention and have no limiting character whatsoever.

### EXAMPLES

### Preparation of the Formulations

To the stirred solvent were added first the agrochemical active ingredients and then the surfactants and customary auxiliaries and additives. The microemulsion concentrates thus prepared were subsequently added to water in a ratio of 1:10, 1:30 and 1:100. This gave microemulsions. The microemulsions were stored at 50 degrees Celsius over a period of 3 months and remained stable over the entire period.

In tables 1 and 2 which follow, the amounts of components combined are stated in % by weight.

TABLE 1

| | Examples | | | | |
|---|---|---|---|---|---|
| | 1 | 3 | 4 | 5 | 6 |
| Fenoxaprop-p-ethyl | 5 | 0 | 0 | 0 | 0 |
| Mefenpyr-diethyl | 0 | 9 | 0 | 0 | 0 |
| Iodosulfuron-methyl-sodium | 0 | 3 | 0 | 0 | 0 |
| Bromoxynil-octanoate | 0 | 0 | 15 | 0 | 0 |
| CMPP-isooctyl | 0 | 0 | 0 | 10 | 0 |
| Mesosulfuron-methyl | 0 | 0 | 0 | 0 | 1 |
| Solvesso ® 200 | 33 | 25 | 26 | 32 | 35 |
| Triethyl phosphate | 12 | 0 | 0 | 0 | 0 |
| N-methyl-pyrrolidone | 0 | 12 | 10 | 10 | 15 |
| Arkopal ® N100 | 20 | 20 | 20 | 0 | 0 |
| Sapogenat ® T-100 | 0 | 0 | 0 | 20 | 20 |
| Emulsogen ® V1816 | 10 | 10 | 12 | 10 | 12 |
| Triton ® GR 7ME | 0 | 15 | 0 | | 0 |
| Phenylsulfonat ® Ca100 | 12 | 0 | 10 | 10 | 10 |
| Genapol ® PF 40 | 6 | 4 | 5 | 6 | 5 |
| Edenol ® D 81 | 2 | 2 | 2 | 2 | 2 |
| Amount: | 100 | 100 | 100 | 100 | 100 |

TABLE 2

| | Examples | | | | | | | |
|---|---|---|---|---|---|---|---|---|
| | 7 | 8 | 9 | 10 | 11 | 12 | 13 | 14 |
| Desmedipham | 2.50 | 0 | 0 | 0 | 2.41 | 2.41 | 0 | 0 |
| Ethofumesate | 0 | 14.75 | 0 | 0 | 0 | 14.75 | 14.75 | 4.75 |
| Metamitron | 0 | 0 | 2.50 | 0 | 0 | 0 | 0 | 2.00 |
| Phenmedipham | 0 | 0 | 0 | 7.30 | 7.30 | 0 | 7.30 | 7.30 |
| Solvesso ® 200 | 34.70 | 22.45 | 34.70 | 39.18 | 32.77 | 25.32 | 20.43 | 28.43 |
| Triethyl phosphate | 10.00 | 10.00 | 10.00 | 10.00 | 5.00 | 5.00 | 5.00 | 5.00 |
| N-methyl-pyrrolidone | 0 | 0 | 0 | 0 | 5.00 | 5.00 | 5.00 | 5.00 |
| Emulsogen ® V1816 | 10.00 | 10.00 | 10.00 | 8.00 | 10.00 | 10.00 | 10.00 | 10.00 |
| Phenylsulfonat ® Ca100 | 10.00 | 10.00 | 10.00 | 10.00 | 10.00 | 10.00 | 10.00 | 10.00 |
| Genapol ® X-060 | 0 | 23.80 | 23.80 | 0 | 0 | 0 | 0 | 0 |
| Genapol ® X-080 | 0 | 0 | 0 | 18.52 | 18.52 | 18.52 | 18.52 | 18.52 |
| Genapol ® PF 40 | 6.00 | 6.00 | 6.00 | 6.00 | 6.00 | 6.00 | 6.00 | 6.00 |
| Edenol ® D 81 | 3.00 | 3.00 | 3.00 | 1.00 | 3.00 | 3.00 | 3.00 | 3.00 |
| Amount: | 100 | 100 | 100 | 100 | 100 | 100 | 100 | 100 |

The commercial products used are detailed hereinbelow:

| | |
|---|---|
| Solvesso ® 200 (Exxon): | mixture of aromatics |
| Arkopal ® N 100 (Clariant): | nonylphenyl ethoxylate with 10 |
| | ethylene oxide units |
| Sapogenat ® T-100 (Clariant): | triisobutylphenol ethoxylate with |
| | 10 ethylene oxide units |
| Emulsogen ® V 1816 (Clariant): | PO/EO block copolymer |
| Triton ® GR 7 ME(Union Carbide): | di(2-ethylhexyl) sulfosuccinate |
| Phenylsulfonat ® Ca 100 (Clariant): | calcium dodecylbenzenesulfonate |
| Genapol ® X-060 (Clariant): | isotridecyl alcohol with 6 |
| | ethylene oxide units |
| Genapol ® X-080 (Clariant): | isotridecyl alcohol with 8 |
| | ethylene oxide units |
| Genapol ® PF 40 (Clariant): | EO/PO/EO block copolymer |
| Edenol ® D 81 (Cognis): | epoxidized soya oil |

We claim:

1. A microemulsion concentrate comprising
a) one or more agrochemical active ingredients,
b) one or more nonalcoholic organic solvents,
c) one or more anionic surfactants, and
d) one or more nonionic surfactants.

2. A microemulsion concentrate as claimed in claim 1, which comprises, as component a), one or more herbicidal active ingredients.

3. A microemulsion concentrate as claimed in claim 1 or 2, which comprises, as component b), one or more solvents from the group hydrocarbons, carboxylic acid derivatives, phosphoric esters, ethers, ketones and sulfoxides.

4. A microemulsion concentrate as claimed in one or more of claims 1 to 3, which comprises, as component c), one or more anionic surfactants from the group sulfates, sulfonates, phosphates and phosphonates of hydrocarbons which can optionally be alkoxylated, preferably alkylarylsulfonates, alkylaryl polyglycol ether phosphate sulfates, alkylaryl polyglycol ether phosphate sulfonates, alkyl ether sulfates, alkyl sulfates, alkylsulfonates, alkyl polyglycol ether phosphates and alkylaryl polyglycol ether phosphates.

5. A microemulsion concentrate as claimed in one or more of claims 1 to 4, which comprises, as component d), one or more nonionic surfactants from the group alkoxylates, preferably alkylaryl polyalkoxylates, alkylene oxide block copolymers, polyalkylene oxides which can be substituted by C₁₀-C₂₂-hydrocarbon radicals, alkoxylated oils, alkoxylated C₁₀-C₂₂-fatty amines.

6. A microemulsion concentrate as claimed in one or more of claims 1 to 5, which additionally comprises conventional auxiliaries and additives.

7. A method for the preparation of a microemulsion concentrate as claimed in one or more of claims 1 to 6, in which the components are mixed.

8. The use of a microemulsion concentrate as claimed in one or more of claims 1 to 6 for the preparation of a microemulsion.

9. An agrochemical composition comprising
a) one or more agrochemical active ingredients,
b) one or more nonalcoholic organic solvents,
c) one or more anionic surfactants,
d) one or more nonionic surfactants, and
e) water.

10. An agrochemical composition as claimed in claim 9, which additionally comprises conventional auxiliaries and additives.

11. An agrochemical composition as claimed in claim 9 or 10, in the form of a microemulsion or of the spray mixture which can be obtained therefrom.

12. An agrochemical composition which is obtainable by diluting a microemulsion concentrate as claimed in one or more of claims 1 to 6 with water.

13. A process for the preparation of an agrochemical composition as claimed in one or more of claims 9-12, in which the components are mixed.

14. A method for controlling harmful organisms, in which an effective amount of an agrochemical composition as claimed in one or more of claims 1 to 6 or 9 to 12 is applied to the harmful organisms or the locations where they occur.

15. A method for controlling undesired vegetation, in which an effective amount of an agrochemical composition as claimed in one or more of claims 1 to 6 or 9 to 12 is applied to the harmful plants, parts of the plants, plant seeds, the area on which the plants grow.

16. The use of an agrochemical composition as claimed in one or more of claims 1 to 6 or 9 to 12 for controlling harmful organisms.

17. The use as claimed in claim 16, wherein the harmful organisms are harmful plants.
